(19) United States
(12) Patent Application Publication
(10) Pub. No.: US 2004/0179677 A1
(43) Pub. Date: Sep. 16, 2004

(54) CONTROL SYSTEM AND METHOD FOR DETERMINING A ROTATIONAL DIRECTION OF A RATCHET

(76) Inventor: Wei-Lie Ching, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,077

(22) Filed: Mar. 14, 2003

(51) Int. Cl. H04M 1/00

(52) U.S. Cl. 379/428.01

(57) ABSTRACT

A control system is used for determining a rotational direction of a ratchet that will output a pair of digital signals. The control system includes a microprocessor and a memory. The microprocessor is electrically connected to the ratchet for receiving the pair of digital signals. Afterwards, the microprocessor will compare the pair of digital signals with the previously stored pair of digital signals to determine if a conditional signal for determining the rotational direction of a ratchet is transmitted to a CPU or not. The memory is electrically connected to the microprocessor for storing the pair of digital signals.

### BACKGROUND OF INVENTION

1. Field of the Invention

The invention relates to a control system and a method for determining a rotational direction of a ratchet, and more particularly, to a control system and a method for determining a state of the ratchet by comparing a phase of digital signals.

2. Description of the Prior Art

Nowadays, the functions of mobile phones are more and more superior and manufacturers of mobile phones are willing to include more and more options and functions of new technology in mobile phones for satisfying all kinds of demands from users. Formerly, a direction apparatus controlling turn-up and turn-down actions of a frame in a mobile phone is usually a set of two buttons and nowadays a ratchet is a good substitute for buttons. The ratchet can activate at least one sensor nearby from a rotation caused by users, and signals produced by the sensors can control a scrolling direction of the frame.

The interface between a mechanical mechanism and an electrical mechanism of the ratchet is more complex, but more suitable for ergonomics and it is convenient for users to scroll the frame rapidly and frequently. The ratchet is often divided into a plurality of sensing areas and each sensing area comprises a plurality of sensors. The rotation relative to the sensor of the ratchet is sensed by the raster of the corresponding sensor, and the sensing result is transmitted to a control circuit connected to sensors. In the prior art of the ratchet, the ratchet often generates a pair of digital signals and the difference between pairs of digital signals is a time delay due to turn-up or turn-down actions. Please refer to FIG. 1 and FIG. 2. FIG. 1 is a schematic diagram of a variation on a time axis of a pair of digital signals (pin0, pin1) in a tune-up condition of the prior art and FIG. 2 is a schematic diagram of a variation on a time axis of a pair of digital signals (pin0, pin1) in a tune-down condition of the prior art. Comparing FIG. 1 and FIG. 2, tune-up or tune-down conditions depend on the time difference between the rising edges of the pair of digital signals. In FIG. 1, the tune-up condition is defined that the pin0 signal rises earlier than the pin1 signal and the time difference between the rising of the pair of digital signals is set to T. A control system of the ratchet of the prior art is capable of judging whether the time difference is T, and if it is, the ratchet will be turned up one step and afterwards the pair of digital signals will return to zero. On the other hand, if the time difference is not T or the pin 1 signal does not rise, the ratchet will stay at the original state. Please refer to FIG. 2. The tune-down condition is defined that the pin1 signal rises earlier than the pin0 signal and the time difference between the rising of the pair of digital signals is set to T. A control system of the ratchet of the prior art is capable of judging whether the time difference is T, and if it is, the ratchet will be turned down one step and afterwards the pair of digital signals will return to zero. On the other hand, if the time difference is not T or the pin 0 signal does not rise, the ratchet will stay at the original state.

Therefore the control system of the ratchet of the prior art provides the method for judging the turn-up or turn-down conditions by checking the time difference between the rising edges of the pair of digital signals. That is to say, when one of the pair of digital signals rises, the control system will check whether the other signal rises and check whether the time difference is in accordance with the condition if the other signal rises. So, the control system of the ratchet of the prior art requires a lot of system resource to operate the foregoing operations. Furthermore, the control system creates delay of the output, and reduces the sensitivity of the ratchet. Therefore, the control system cannot allow users to scroll the frame rapidly and fluently, and also cannot achieve real time operation completely.

### SUMMARY OF INVENTION

It is therefore a primary objective of the claimed invention to provide a system and a method for determining a state of a ratchet by comparing a phase of digital signals instead of comparing a time difference to solve the above-mentioned problem of the prior art.

According to the claimed invention, a control system for controlling operations of a ratchet is capable of generating a pair of digital signals. The control system comprises a microprocessor electrically connected to the ratchet for receiving the pair of digital signals and comparing a phase of the pair of digital signals with a phase of a previously stored pair of digital signals to determine if a conditional signal for determining a rotational direction of the ratchet is transmitted to a CPU or not, and a memory electrically connected to the microprocessor for storing the pair of digital signals.

According to the claimed invention, a control method of determining a condition of a rotational direction of a ratchet comprises outputting a pair of digital signals separately from the ratchet, receiving the pair of digital signals with a microprocessor electrically connected to the ratchet, and comparing a phase of the pair of digital signals with a phase of a previously stored pair of digital signals by the microprocessor, wherein conditions of the ratchet comprise a turn-up condition, a turn-down condition, and other conditions.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a variation on a time axis of a pair of digital signals (pin0, pin1) in tune-up condition of a ratchet of the prior art.

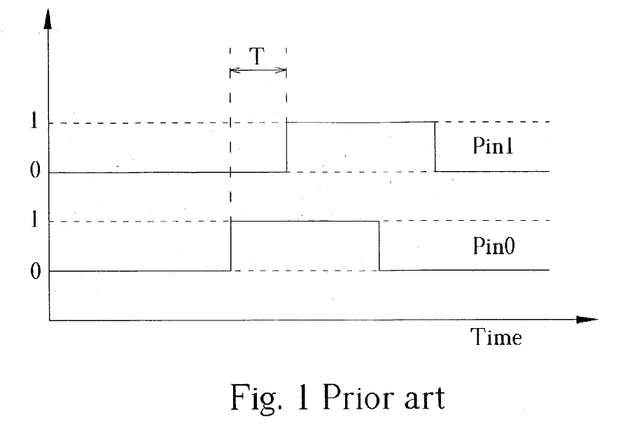

FIG. 2 is a schematic diagram of a variation on a time axis of the pair of digital signals (pin0, pin1) in tune-down condition of the ratchet of the prior art.

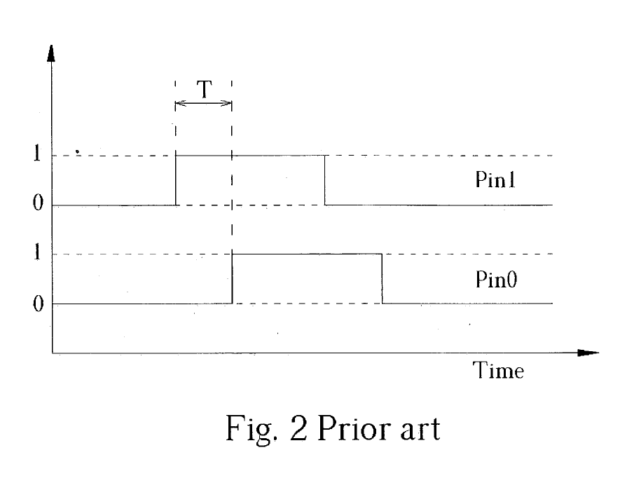

FIG. 3 is a schematic diagram of the ratchet according to the present invention.

FIG. 4 is a table of locations of signals in the ratchet.

FIG. 5 is a schematic diagram of a control system of the ratchet.

FIG. 6 is a table of conditions of the control system.

### DETAILED DESCRIPTION

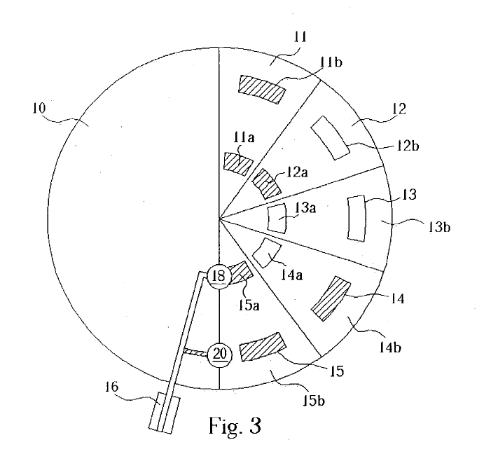

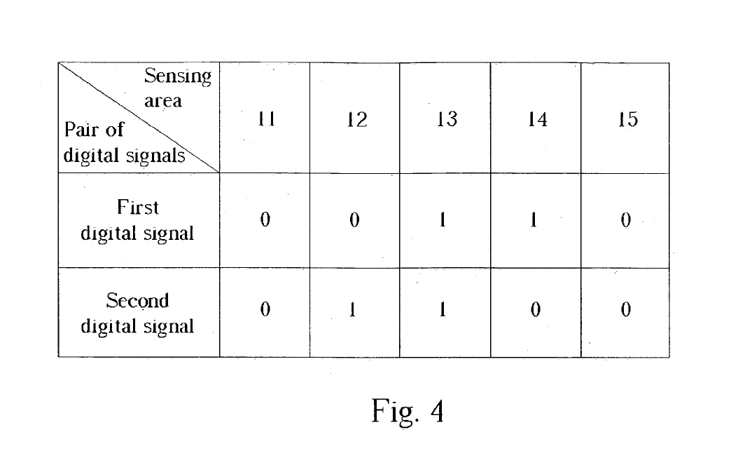

Please refer to FIG. 3 and FIG. 4. FIG. 3 is a schematic diagram of a ratchet 10 according to the present invention and FIG. 4 is a table of locations of signals in the ratchet 10. The ratchet 10 comprises a plurality of sensing areas 11-15, and each sensing area comprises two sensing sections 11a, 11b to 15a, 15b and a relative rotation to a sensing apparatus 16 of the ratchet 10 is sensed by the raster of the corresponding sensor. The ratchet 10 comprises a circular turning wheel and the sensing apparatus 16 comprising of two sensors 18, 20. The circular turning wheel comprises a plurality of sensing areas separately and the embodiment reveals five sensing areas 11-15. The sensor 18 can sense the first sensing sections 11a-15a in the sensing areas 11-15 and the sensor 20 can sense the second sensing sections 11b-15b in the sensing areas 11-15. When users turn the ratchet 10 backwards and forwards between the sensing areas 11-15, the sensors 18, 20 of the sensing apparatus 16 can sense the movement between the sensing areas 11-15 and generate a pair of digital signals in each sensing area as shown in FIG. 4. The sensor 18 senses the first sensing sections 11a-15a and generates the first digital signal in FIG. 4 and the sensor 20 senses the second sensing sections 11b-15b and generates the second digital signal in FIG. 4.

In FIG. 3 the sensing areas 11-15 locates on the turning wheel isogonally and the turning wheel can rotate backwards and forwards between the sensing areas 1′-15. Each sensing area 11-15 comprises the first sensing section 11a-15a sensed by the sensor 18 and the second sensing section 11b-15b sensed by the sensor 20 and the sensors 18, 20 generates the pair of digital signals of the sensing areas 11-15 in FIG. 4.

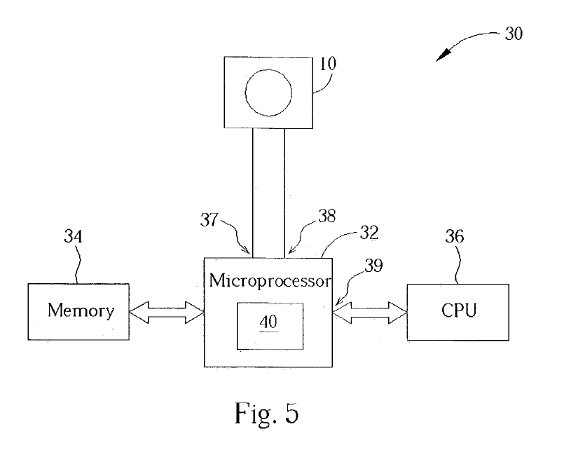

Please refer to the ratchet 10 in FIG. 3 and the table of locations of signals in FIG. 4, the present invention utilizes the phase difference (the change between 0 and 1) instead of the time difference for judging the conditions of the ratchet 10 in FIG. 3. Please refer to FIG. 5, FIG. 5 is a schematic diagram of a control system 30 of the ratchet 10. The control system 30 comprises a microprocessor 32, a memory 34, and a CPU 36. The microprocessor 32 includes two receiving ports 37, 38 electrically connected to the ratchet 10 in FIG. 3 for receiving the pair of digital signals from the ratchet 10 and a transmitting port 39 electrically connected to the CPU 36 for transmitting a conditional signal from the ratchet 10 to the CPU 36. The memory 34 is electrically connected to the microprocessor 32 for storing the pair of digital signals from the ratchet 10. The CPU 36 is also electrically connected to the microprocessor 32 and operates the related command according to the conditional signal after receiving the conditional signal.

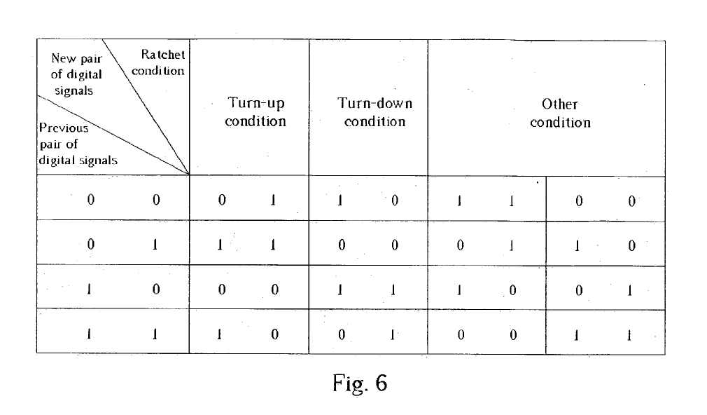

Furthermore, the microprocessor 32 comprises a control program 40 for processing a pair of digital signals from the ratchet 10 and storing the processed pair of digital signals in the memory 34 to substitute for a previously stored pair of digital signals. When users turn the ratchet 10, the ratchet 10 will generate the corresponding pair of digital signals immediately to the control program 40 and the control program 40 will compare the phase of the new pair of digital signals with the phase of the previously stored pair of digital signals to determine what the turn-up condition or the turn-down condition is. Please refer to FIG. 6, FIG. 6 is a table of conditions of the control system 30. After the control program 40 compares the phase of the new pair of digital signals with the phase of the previously stored pair of digital signals, the microprocessor 32 will transmit the conditional signal containing turn-up or turn-down conditions to the CPU 36 if the change of the phase is in accordance with turn-up or turn-down conditions in FIG. 6 and then store the new pair of digital signals in the memory 34. For example, if the new pair of digital signals is (1, 1) and the previously stored pair of digital signals is (0, 1), the control program 40 will regard this as the turn-up condition and transmit the turn-up conditional signal to the CPU 36 according to the table of conditions of the control system 30 in FIG. 6, and the CPU 36 will operate a related action like moving the cursor to the upper item on the screen.

After the control program 40 compares the phase of the new pair of digital signals with the phase of the previously stored pair of digital signals, the microprocessor 32 will not transmit the conditional signal containing turn-up or turn-down conditions to the CPU 36 if there is no change of the phase or the change of the phase is not in accordance with turn-up or turn-down conditions in FIG. 6. Then the microprocessor 32 will store the new pair of digital signals in the memory 34 and will not transmit any signal to the CPU 36, and the CPU will not operate any action.

In addition, the control system 40 is one of the subroutines of the microprocessor 32 and the microprocessor 32 controls other functions simultaneously like the power management of cellular phones. The microprocessor 32 is capable of detecting the pair of digital signals from the ratchet 10 and operating the control program 40 during a stationary period.

In contrast to the prior art control system of the ratchet which determines a state of a ratchet by comparing a time difference of digital signals, the control system of the ratchet in the present invention utilizes a memory for storing the last digital signals from the ratchet and a microprocessor for comparing a phase of digital signals to determine the condition of the ratchet. Therefore the control system of the ratchet in the present invention does not require a lot of system resources in time-difference operation and it can allow users to scroll the frame rapidly and fluently.

Those skilled in the art will readily observe that numerous modifications and alterations of the method and system may be made while retaining the teachings of the invention. Accordingly, the above disclosure should be construed as limited only by the metes and bounds of the appended claims.

What is claimed is:

1. A control system for controlling operations of a ratchet, which is capable of generating a pair of digital signals, the control system comprising:
a microprocessor electrically connected to the ratchet for receiving the pair of digital signals and comparing a phase of the pair of digital signals with a phase of a previously stored pair of digital signals to determine if a conditional signal for determining a rotational direction of the ratchet is transmitted to a CPU or not; and
a memory electrically connected to the microprocessor for storing the pair of digital signals.

2. The control system of claim 1 wherein the CPU electrically connected to the microprocessor receives the conditional signal and operates a related command according to the conditional signal.

3. The control system of claim 1 wherein the microprocessor comprises:
at least one receiving port electrically connected to the ratchet for receiving the pair of digital signals from the ratchet; and
a control program for receiving the pair of digital signals and comparing the phase of the pair of digital signals with the phase of the previously stored pair of digital signals.

4. The control system of claim 3 wherein the control program is capable of transmitting the conditional signal containing turn-up and turn-down conditions to the CPU from the microprocessor and asking the microprocessor to write the pair of digital signals into the memory according to whether the change of the phase is in accordance with turn-up and turn-down conditions by comparing the pair of digital signals with the previously stored pair of digital signals.

5. The control system of claim 3 wherein the control program is capable of asking the microprocessor to write the pair of digital signals into the memory and not transmitting any signal to the CPU if there is no change in phase or if the change of the phase is not in accordance with turn-up and turn-down conditions by comparing the pair of digital signals with the previously stored pair of digital signals.

6. The control system of claim 3 wherein the microprocessor is capable of detecting the pair of digital signals and operating the control program during a stationary period.

7. The control system of claim 1 wherein the ratchet comprises a plurality of sensing areas, and each sensing area comprises a plurality of sensors.

8. The control system of claim 7 wherein the ratchet comprises a sensing apparatus capable of sensing the rotational direction of the ratchet related to the sensing apparatus, and the sensing apparatus comprises the plurality of sensors for generating a one bit digital signal based on each sensor in the sensing area while the ratchet is rotating.

9. A control method of determining a condition of a ratchet comprising:
outputting a pair of digital signals separately from the ratchet;
receiving the pair of digital signals with a microprocessor electrically connected to the ratchet; and
comparing a phase of the pair of digital signals with a phase of a previously stored pair of digital signals by the microprocessor;
wherein conditions of the ratchet comprise a turn-up condition, a turn-down condition, and other conditions.

10. The control method of claim 9 wherein the microprocessor comprises:
at least one receiving port electrically connected to the ratchet for receiving the pair of digital signals from the ratchet;
a control program for receiving the pair of digital signals and comparing the phase of the pair of digital signals with the phase of the previously stored pair of digital signals; and
at least one transmitting port electrically connected to a CPU for transmitting a conditional signal from the ratchet to the CPU.

11. The control method of claim 10 further comprising the control program transmitting the conditional signal containing turn-up and turn-down conditions to the CPU from the microprocessor and asking the microprocessor to write the pair of digital signals into the memory according to whether change of the phase is in accordance with turn-up and turn-down conditions by comparing the pair of digital signals with the previously stored pair of digital signals.

12. The control method of claim 10 further comprising the control program asking the microprocessor to write the pair of digital signals into the memory and not transmitting any signal to the CPU if is no change in phase or if the change of the phase is not in accordance with turn-up and turn-down conditions by comparing the pair of digital signals with the previously stored pair of digital signals.

13. The control method of claim 10 wherein the microprocessor is capable of detecting the pair of digital signals and operating the control program during a stationary period.

14. The control method of claim 10 wherein the CPU operates the related command according to the conditional signal after receiving the conditional signal.

15. The control system of claim 9 wherein the ratchet comprises a plurality of sensing areas, and each sensing area comprises a plurality of sensors.

16. The control system of claim 15 wherein the ratchet comprises a sensing apparatus being capable of sensing the rotational direction of the ratchet related to the sensing apparatus, and the sensing apparatus comprises the plurality of sensors for generating a one bit digital signal based on each sensor in the sensing area while the ratchet is rotating.
